(19) United States
(12) Patent Application Publication
(10) Pub. No.: US 2026/0111201 A1
(43) Pub. Date: Apr. 23, 2026

(54) TECHNIQUES TO ENFORCE STANDARDS COMPLIANCE FOR CONTINUOUS INTEGRATION AND CONTINUOUS DEPLOYMENT PIPELINES

(71) Applicant: Ally Financial Inc., Detroit, MI (US)

(72) Inventors: Vamsi Krishna Vaukulabharanam Siripurapu, Fort Mil, SC (US); Ramakrishna Kothur, Concord, NC (US)

(21) Appl. No.: 18/923,162

(22) Filed: Oct. 22, 2024

(51) Int. Cl. G06F 8/60; G06F 8/70

(52) U.S. Cl. CPC G06F 8/60; G06F 8/70

(57) ABSTRACT

Methods, systems, and devices for data management are described. A continuous integration and continuous deployment (CI/CD) pipeline may implement an automatic scanning procedure to enforce compliance of the CI/CD pipeline with one or more standards for computer systems and software applicable for the development and deployment of an application. In some aspects, the automatic scanning procedure may include obtaining a compliance policy from an application programming interface (API) associated with the application, and performing one or more static code scans, secret detection scans, container security scans, dependency scans, or any combination thereof, to enforce compliance of the CI/CD pipeline with the one or more standards. In some cases, the automatic scanning procedure may also output a message which indicates the results of the one or more static code scans, secret detection scans, container security scans, dependency scans, or any combination thereof.

### FIELD OF TECHNOLOGY

The present disclosure relates generally to data management and security, including techniques for techniques to enforce standards compliance for continuous integration and continuous deployment (CI/CD) pipelines.

### BACKGROUND

An organization may include multiple teams of engineers and developers that develop applications (e.g., computing applications and software related to financial institutions, user connectivity, user engagement, or the like) that support data storage and other implementations. In some aspects, a data management system (DMS) may be employed to manage data associated with such computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data management services for data of the one or more computing systems, and may comply with one or more data security standards. Improved data management and standards compliance may offer improved performance with respect to reliability, speed, efficiency, scalability, security, data safety, among other possible aspects of performance.

### BRIEF DESCRIPTION OF THE DRAWINGS

FIG. 1 illustrates an example of a computing environment that supports techniques to enforce standards compliance for continuous integration and continuous deployment (CI/CD) pipelines in accordance with aspects of the present disclosure.

FIG. 2 shows an example of a CI/CD pipeline that supports techniques to enforce standards compliance for CI/CD pipelines in accordance with aspects of the present disclosure.

FIG. 3 shows an example of an integrated CI/CD compliance scanner that supports techniques to enforce standards compliance for CI/CD pipelines in accordance with aspects of the present disclosure.

FIG. 4 shows an example of a process flow that supports techniques to enforce standards compliance for CI/CD pipelines in accordance with aspects of the present disclosure.

FIG. 5 shows a block diagram of an apparatus that supports techniques to enforce standards compliance for CI/CD pipelines in accordance with aspects of the present disclosure.

FIG. 6 shows a block diagram of a compliance policy implementation manager that supports techniques to enforce standards compliance for CI/CD pipelines in accordance with aspects of the present disclosure.

FIG. 7 shows a diagram of a system including a device that supports techniques to enforce standards compliance for CI/CD pipelines in accordance with aspects of the present disclosure.

FIG. 8 shows a flowchart illustrating methods that support techniques to enforce standards compliance for CI/CD pipelines in accordance with aspects of the present disclosure.

### DETAILED DESCRIPTION

Institutions may implement a continuous integration and continuous deployment (CI/CD) pipeline (which may also be referred to as a continuous integration/continuous delivery pipeline or other similar terminology), which may automate software development workflows to allow for the development and deployment of high quality code. A CI/CD pipeline may support a continuous and iterative process to build, test, and deploy software (and software updates) such that the need for manual intervention and avoids bugs and code failures may be minimized or reduced. The implementation of a CI/CD pipeline may realize various advantages for institutions that regularly develop and deploy software. For example, use of a CI/CD pipeline may allow for relatively faster automatic detection of issues or bugs present in code as it is being developed, which reduces the likelihood of expensive and time-consuming fixes later in development. The use of a CI/CD pipeline may also allow institutions to create, test, and automatically deploy software features with minimal manual intervention. In addition, various features to check developed code may be integrated into the CI/CD pipeline. After checks of the code are preformed, the code may be deployed to various environments including a quality assurance stage, staging, and production environments. The CI/CD pipeline may also allow for rapid rollback of changes, for example, in the event that new features cause challenges with existing software, the CI/CD pipeline may allow developers to immediately return the software to a previous state, and rapidly implement fixes.

In some implementations, a CI/CD pipeline may support automatic compliance checks to ensure that developing applications comply with various standards to reduce the likelihood of security vulnerabilities and regulatory non-compliance. For example, a CI/CD pipeline may include integrated checks and scans to support proper compliance with various standards, including cybersecurity and software standards tailored to specific industries. In some cases, the software being developed by the CI/CD pipeline may be deployed by a financial institution, which may need to be in compliance with various data security standards mandated for financial industries (e.g., which may be specific to finance-based organizations), along with other standards set by individual financial organizations. Additionally, or alternatively, the software associated with the CI/CD pipeline may need to be in compliance with standards set in place by various different standards bodies, such as the National Institute of Standards and Technology (NIST), the Federal Financial Institutions Examination Council (FFIEC), and the Federal Reserve Board (FRB), among other examples, which may collectively contribute to the establishment of standards than impact information security, encryption, and financial institution practices.

Such standards may impact the development, upkeep, and security protocols of one or more software systems and/or applications of an organization, and adherence to these standards may have a direct impact on the operations of an organization. In some cases, however, ensuring that an organization's applications and/or software are in compliance with such standards may be labor intensive and time consuming. In addition, it may be possible to disable (e.g., intentionally or unintentionally) one or more security measures that relate to standards compliance, and improved techniques may be desirable to ensure that the integrity of various software and/or applications is maintained.

As described herein, to adhere to standards and to ensure that the development of software facilitated by the CI/CD pipeline meets compliance assessments and regulatory examinations, an organization may support a compliance guard package that integrates automatic compliance checks and compliance measures within the CI/CD pipeline to enforce compliance of the software development with established standards throughout the development cycle. The compliance guard package may support various different automated scans and checks that are integrated in the CI/CD pipeline. For example, the compliance guard package may integrate static code scans, secret detection scans, policy-as-code (PaC) checks, container security scanning, dependency scanning, compliance dashboards and reporting, automated audit and reporting, continuous monitoring, feedback loops and notifications, other security scans, or any combination thereof. The integration of the compliance guard package may allow for more secure and compliant development with software using a CI/CD pipeline.

The techniques described herein may be implemented to realize one or more potential advantages. For example, by automatically checking for compliance to established standards at each stage of the CI/CD pipeline, an organization may improve the quality of released software and ensure that customer data is protected based on the most up-to-date cyber security standards. Additionally, or alternatively, the implementation of automated compliance checks within a CI/CD pipeline may reduce the likelihood that institutions are able to bypass compliance checks and release noncompliant software. Additionally, or alternatively, the implementation of automated compliance checks within the CI/CD pipeline may support intuitive monitoring for compliance and reduced complexity for addressing and mitigating noncompliant software.

Aspects of the disclosure are initially described in the context of systems, computing environments, CI/CD pipelines, and an integrated CI/CD compliance scanner. Aspects of the disclosure are then described with reference to process flows, block diagrams, and flowcharts that relate to techniques to enforce standards compliance for CI/CD pipelines.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

It should be appreciated by a person skilled in the art that one or more aspects of the disclosure may be implemented in a system to additionally, or alternatively, solve other problems than those described herein. Further, aspects of the disclosure may provide technical improvements to “conventional”systems or processes as described herein. However, the description and appended drawings only include example technical improvements resulting from implementing aspects of the disclosure, and accordingly do not represent all of the technical improvements provided within the scope of the claims.

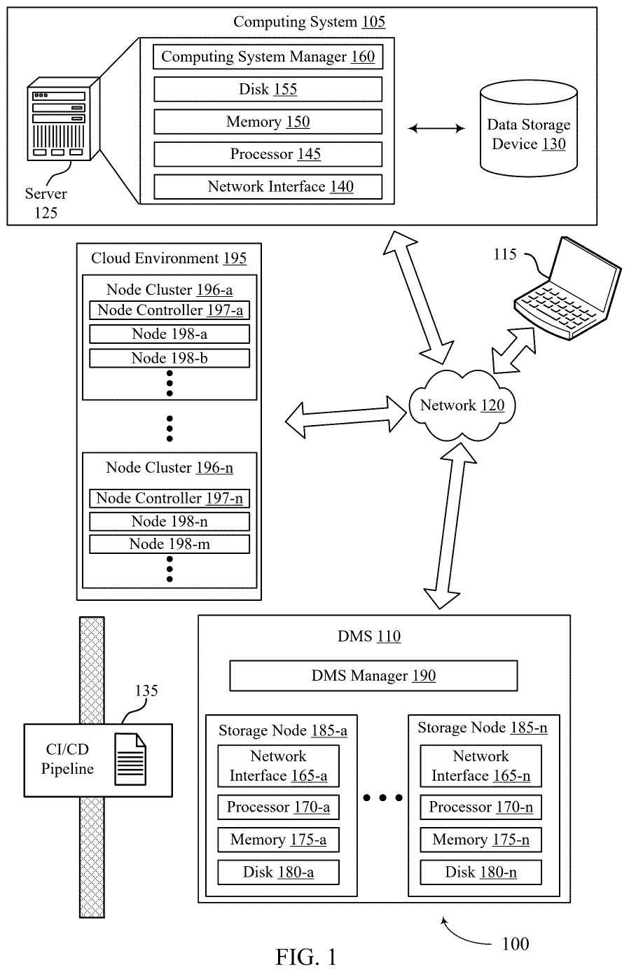

FIG. 1 illustrates an example of a computing environment 100 that supports techniques to enforce standards compliance for CI/CD pipelines in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may support one or more different software releases, may provide a data backup service, a data classification and storage service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may function as an application server or a file server. In general, a server 125 may refer to one or more hardware devices that function as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory (ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, where shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructureas-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes (e.g., storage node 185-a through storage node 185-n). The DMS manager 190 may manage operation of the DMS 110, including the storage node 185-a through storage node 185-n. Though illustrated as a separate entity within the DMS 110, the DMS manager 190 may in some cases be implemented (e.g., as a software application) by one or more of the storage nodes. In some examples, the storage nodes may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes of the DMS 110 may include respective network interfaces (e.g., network interface 165-a through network interface 165-n), processors (e.g., processor 170-a through processor 170-n), memories (e.g., memory 175-a through memory 175-n), and disks (e.g., disk 180-a through disk 180-n). The network interfaces may enable the storage nodes to connect to one another, to the network 120, or both. A network interface may include one or more wireless network interfaces, one or more wired network interfaces, or any combination thereof. The processor of a storage node may execute computer-readable instructions stored in the memory of the storage node in order to cause the storage node to perform processes described herein as performed by the storage node. A processor may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk may include one or more HDDs, one or more SDDs, or any combination thereof. Memories and disks may comprise hardware storage devices. Collectively, the storage nodes may in some cases be referred to as a storage cluster or as a cluster of storage nodes.

In some examples, the DMS 110, and in particular the DMS manager 190, may be referred to as a control plane. The control plane may manage tasks, such as storing data management data or performing restorations, among other possible examples. The control plane may be common to multiple customers or tenants of the DMS 110. For example, the computing system 105 may be associated with a first customer or tenant of the DMS 110, and the DMS 110 may similarly provide data management services for one or more other computing systems associated with one or more additional customers or tenants. In some examples, the control plane may be configured to manage the transfer of data management data (e.g., snapshots associated with the computing system 105) to a cloud environment 195 (e.g., Microsoft Azure or Amazon Web Services). In addition, or as an alternative, to being configured to manage the transfer of data management data to the cloud environment 195, the control plane may be configured to transfer metadata for the data management data to the cloud environment 195. The metadata may be configured to facilitate storage of the stored data management data, the management of the stored management data, the processing of the stored management data, the restoration of the stored data management data, and the like.

Each customer or tenant of the DMS 110 may have a private data plane, where a data plane may include a location at which customer or tenant data is stored. For example, each private data plane for each customer or tenant may include a node cluster (e.g., node cluster 196-a through node cluster 196-n) across which data (e.g., data management data, metadata for data management data, etc.) for a customer or tenant is stored. Each node cluster may include a node controller (e.g., node controller 197-a through node controller 197-n) which manages the nodes of the node cluster (e.g., node 198-a, node 198-b, through node 198-n, node 198-m). As an example, a node cluster for one tenant or customer may be hosted on Microsoft Azure, and another node cluster may be hosted on Amazon Web Services. In another example, multiple separate node clusters for multiple different customers or tenants may be hosted on Microsoft Azure. Separating each customer or tenant's data into separate node clusters provides fault isolation for the different customers or tenants and provides security by limiting access to data for each customer or tenant.

The DMS 110 may provide services to support proper compliance with various standards, including cybersecurity and software standards tailored to specific industries. For example, the DMS 110 may support a financial institution which may be in compliance with various data security standards mandated for financial industries, along with other individual standards set by individual financial organizations. For example, the DMS 110 may support enforcement and compliance with standards set in place by various different standards bodies, such as the National Institute of Standards and Technology (NIST), the Federal Financial Institutions Examination Council (FFIEC), and the Federal Reserve Board (FRB), which may collectively contribute to the establishment of standards than impact information security, encryption, and financial institution practices.

In some implementations, the DMS 110 may support compliance of software and computing systems with various NIST standards, or other federally enforced or implemented standards. For example, NIST is a United States-specific federal agency that develops and promotes measurement standards, although the DMS 110 may support compliance of software and computing systems for other non-United States-based agencies. Some example standards may include software standards, computing standards, cybersecurity standards, and other organizational standards.

In some examples, an organization may comply with Federal Information Processing Standards (FIPS) which may establish security and interoperability standards for computer systems utilized by a government (such as by the United States government). In some aspects, FIPS may apply to encryption algorithms, key management, and security for hash functions, among other security standards. Additionally, or alternatively, an organization may comply with NIST special publications (SP) which provide guidelines, best practices, and recommendations for various aspects of information security and software development. For example, some such publications may include security and privacy controls for federal information systems and organizations, protections for controlled unclassified information in nonfederal systems and organizations, among other publications. Additionally, or alternatively, an organization may comply with a cybersecurity frameworks which may help manage and improve cybersecurity protocols for the organization by providing a set of guidelines and best practices for identifying, protecting, detecting, responding to, and recovering from cybersecurity incidents. Additionally, or alternatively, an organization may comply with a risk management framework (RMF), which may include a set of guidelines for managing information security risk in federal information systems. In some aspects, the RMF may provide a structured process for organizations to assess and manage risk throughout the system development life cycle. An organization may comply with a secure software development framework, which may support secure software development practices, including guidelines for integrating security into the software development life cycle, implementation of secure coding practices, and integration of vulnerability management processes. In some examples, vulnerability management processes may include integration of a common vulnerability scoring system (CVSS), which may include a standardized framework for assessing and scoring the severity of software vulnerabilities such that the organization may effectively prioritize and address security vulnerabilities. Additionally, or alternatively, an organization may receive software assurance guidance, which may support building of secure and reliable software, including support for secure coding practices and tools for assessing and improving software security.

In some implementations, the DMS 110 may support compliance of software and computing systems with various FFIEC standards. For example, FFIEC may set various compliance standards for financial institutions to ensure the security and resilience of information systems. In some examples, an organization may comply with information security standards, including compliance with various guidelines for implementing and maintaining effective information security programs, with an emphasis on protective sensitive financial information and financial data from unauthorized access. Such security programs may support data confidentiality, integrity, and availability. Additionally, or alternatively, an organization may comply with various risk management standards and robust risk management practices to identify, assess, and mitigate risks associated with information security, technology, and business operations. Additionally, or alternatively, an organization may comply with various access control standards, which may control and manage access to information systems and sensitive data, allowing only authorized individuals to gain access to appropriate resources (e.g., based on roles and responsibilities of the individuals).

Additionally, or alternatively, an organization may comply with various incident response and resilience standards, including guidelines for developing and maintaining comprehensive and robust incident response plans, including an emphasis on abilities to detect, respond to, and recover from cybersecurity incidents (e.g., data breaches, ransomware attacks, among other incidents). In some examples, an organization may also (or alternatively) comply with business continuity planning standards, which may allow for maintaining business continuity to insure the availability of critical systems and services during disruptions or disasters. Additionally, or alternatively, an organization may comply with various secure software development practices including secure coding practices in the development and maintenance of software systems (e.g., for financial institutions or other institutions). In some cases, an organization may comply with various standards for managing and mitigating risks associated with third-party service providers, with an emphasis on due-diligence and ongoing security monitoring. An organization may comply with training and awareness standards, including guidelines for providing training and awareness programs to employees to enhance understanding of information security risks and best practices. Additionally, or alternatively, an organization may comply with various compliance assessment standards, which include compliance with expectations for financial institutions to conduct regular assessments to ensure compliance with FFIEC guidelines and address any identified deficiencies.

Collectively, standards may impact the development, upkeep, and ongoing security protocol implementation of software systems. An organization may be tasked with ensuring compliance with the guidelines, standards, and recommendations from state and federal agencies, including NIST, FFIEC, FIPS, while also engaging in collaboration with regulatory entities like FRB. Such compliance ensures the establishment of robust cybersecurity measures, compliance with regulatory obligations, and safeguarding sensitive information against diverse threats, especially when the organization stores and utilizes large amounts of sensitive data. Regular compliance assessments, often carried out through regulatory examinations, validate the adherence of an organization to these standards, preserving the integrity and security of implemented systems.

A DMS 110 may support deployment of a CI/CD pipeline 135, which may allow for the automation of software development and testing by supporting the automated building, testing, and deployment of different versions of software and applications. In some aspects, the CI/CD pipeline 135 may reduce the likelihood of manual errors through automation and may provide standardized feedback loops for developers to check for accurate code development. The CI/CD pipeline 135 may support a process that drives software development through a path of building, testing, and deploying code. By automating the process, human error is reduced, and more consistent versions of software may be developed. Some processes included in the CI/CD pipeline 135 include compiling code, unit tests, code analysis, security, and binaries creation. For containerized environments, the CI/CD pipeline 135 may also include packaging the code into a container image to be deployed across a hybrid cloud.

The usage of the automated CI/CD pipeline 135 may introduce some challenges to the development and deployment of software that complies with various standards, including standards that invoke scanning measures mandated by state and federal agencies, and individual organizations compliance teams. For example, in at least some cases, developers and application owners can intentionally or unintentionally bypass standards compliance measures by disabling security scan tools or commenting on stages and/or jobs responsible for standards compliance checks within the CI/CD pipeline 135. Such bypassing results in the production of non-compliant applications, with non-compliance issues remaining unidentified until the compliance assessment stage. The oversight of compliance checks within the CI/CD pipeline 135 may incur additional costs for institutions, and may allow for the deviations from established standards to go unnoticed until late in the development process, which may introduce security vulnerabilities and regulatory non-compliance.

A DMS 110 may implement various techniques to fortify the integrity of the CI/CD pipeline 135, to prevent any unauthorized bypassing of scans, and to ensure continuous compliance throughout the software development lifecycle. For example, in order to adhere to standards and to ensure that the development of software facilitated by the CI/CD pipeline 135 meets compliance assessments and regulatory examinations, an organization may support a “compliance guard” package which integrates automated checks and compliance measures within the CI/CD pipeline 135 to enforce compliance of the software development with established standards throughout the development cycle. In some aspects, the compliance guard package may be developed using a programming language such as Python (although other languages are possible), and may be compatible with applications regardless of the programming language used to build the applications.

The compliance guard package may support various different built-in (e.g., automated) scans and checks that are integrated in the CI/CD pipeline 135 to ensure compliance throughout the software development lifecycle. For example, the compliance guard package may integrate static code scans, secret detection scans, PaC checks, container security scanning, dependency scanning, compliance dashboards and reporting, automated audit and reporting, continuous monitoring, feedback loops and notifications, other security scans, or any combination thereof. The integration of the compliance guard package may allow for more secure and compliant development with software using a CI/CD pipeline 135, especially for industries in which alignment with standards and data security is of high importance.

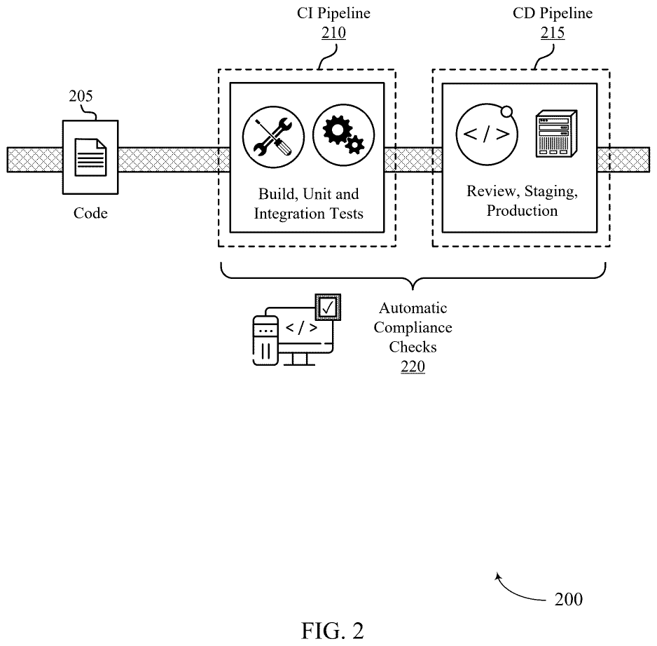

FIG. 2 shows an example of a CI/CD pipeline 200 that supports techniques to enforce standards compliance for CI/CD pipelines in accordance with aspects of the present disclosure. For example, the CI/CD pipeline 200 may support automated development and deployment of software, and may also include integrated scanning and automatic compliance check processes to enforce compliance with industry and institutional standards.

The implementation of a CI/CD pipeline may realize various advantages for organizations that develop software, including regularly testing and deploying code 205. For example, use of a CI/CD pipeline may allow for relatively faster automatic detection of issues or bugs present in code 205 (e.g., as it is being developed), which reduces the likelihood of expensive and time-consuming fixes later in development. The use of a CI/CD pipeline may also allow institutions to create, test, and automatically deploy software features with minimal manual intervention. In addition, various features to check developed code may be integrated into the CI/CD pipeline. After one or more checks of the code 205 are preformed, the code 205 may be deployed to various environments including a quality assurance stage, staging, and production environments. The CI/CD pipeline may also allow for rapid rollback of changes, for example, in the event that new features cause challenges with existing software, the CI/CD pipeline may allow developers to immediately return the software to a previous state, and rapidly implement fixes.

The CI/CD pipeline 200 supports an automated process utilized by software developers to streamline the creation, testing and deployment of applications. The CI pipeline 210 includes continuous integration, where developers may merge code changes into a central repository, allowing early detection of issues or possible bugs in the code 205. For example, the CI pipeline 210 may integrate continuous tests to identify bugs as they are introduced into the code 205. The continuous testing may include unit testing (e.g., checks that individual units of code work as expected), integration testing (e.g., verifies how different modules or services within an application work together), and regression testing (e.g., performed after bug fixes to ensure the bug does not occur again). The CD pipeline 215 includes continuous deployment or continuous delivery, which automates the review, staging, production, and release of the application or software to the intended environment, ensuring that the application is readily available to users.

In some implementations, the CI/CD pipeline 200 may support automatic compliance checks 220 to ensure that developing applications comply with various standards to reduce the likelihood of security vulnerabilities and regulatory non-compliance. To adhere to standards and to ensure that the development of software facilitated by the CI/CD pipeline 200 meets compliance assessments and regulatory examinations, an organization may support a compliance guard package which integrates automatic compliance checks 220 and compliance measures within the CI/CD pipeline 200 to enforce compliance of the software development with established standards throughout the development cycle.

The compliance guard package may support various built-in (e.g., automated) scans and checks that are integrated in the CI/CD pipeline 200. For example, the compliance guard package may integrate static code scans, secret detection scans, PaC checks, container security scanning, dependency scanning, compliance dashboards and reporting, automated audit and reporting, continuous monitoring, feedback loops and notifications, other security scans, or any combination thereof. The integration of the compliance guard package may allow for more secure and compliant development with software using a CI/CD pipeline 200, and various features described herein may be automated to enable robust integrity of the software.

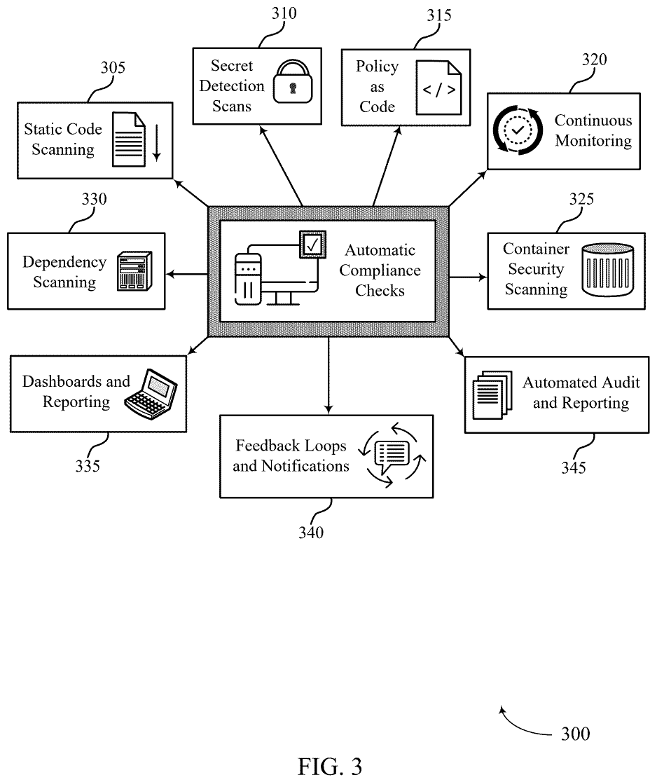

FIG. 3 shows an example of an integrated CI/CD compliance scanner 300 that supports techniques to enforce standards compliance for CI/CD pipelines in accordance with aspects of the present disclosure. For example, the integrated CI/CD compliance scanner 300 may include various built-in compliance check and scanning procedures for a CI/CD pipeline, so that the CI/CD pipeline does not produce non-compliant applications or software.

In some implementations, the integrated CI/CD compliance scanner 300 may include static code scans 305. For example, the static code scans 305 may support an automated repositories analysis and static code scanning which scans code for adherence to coding standards, security best practices, adherence to various industry or institutional standards, among other relevant guidelines. In some examples, the static code scans 305 may be integrated into the CI/CD pipeline to analyze and scan code before deployment of the code.

In some implementations, the integrated CI/CD compliance scanner 300 may include secret detection scans 310, which may support automated code repository analyses and enforcement of secret detection within the CI/CD pipeline. For example, the secret detection scans 310 may include scanning of the code which ensures that there are no potential leaks of sensitive information in the code (e.g., sensitive information including secrets and personally identifiable information (PII)).

In some implementations, the integrated CI/CD compliance scanner 300 may include PaC frameworks 315 to define and enforce compliance policies in a machine readable format. PaC checks may be integrated into the CI/CD pipeline to ensure that applications and software meet predefined standards, including federal, industry, and institutional standards.

In some implementations, the integrated CI/CD compliance scanner 300 may include continuous monitoring techniques 320 which may provide real-time insights into application security and adherence to various outlined compliance policies. In some examples, the continuous monitoring techniques 320 may, in real-time, detect deviations from standards and respond to (e.g., mitigate or remediate) the deviations in order to bring the application back to compliance.

In some implementations, the integrated CI/CD compliance scanner 300 may include container security scanning 325 which may include automated repositories analysis to ensure that container security scanning tools are included an executed in the CI/CD pipeline. In some examples, the container security scanning 325 may assess the security posture of containerized applications and their dependencies that are in development by the CI/CD pipeline.

In some implementations, the integrated CI/CD compliance scanner 300 may include dependency scanning 330 which may include automated repositories analysis to ensure that integration and execution of automated dependency scanning tools within the CI/CD pipeline. For example, the dependency scanning 330 may support detection of vulnerabilities or outdated dependencies associated with an application. In some examples, the dependency scanning 330 may be incorporated into the CI/CD pipeline to ensure that applications utilize secure and up-to-date code libraries.

In some implementations, the integrated CI/CD compliance scanner 300 may include integration of various compliance dashboards and reporting mechanisms 335, which may provide visibility into compliance statuses for applications at each stage of development within the CI/CD pipeline. In some examples, the compliance dashboards and reporting mechanisms 335 may be available to developers and stakeholders to track, analyze, and address compliance status continuously, and may allow developers and stakeholders to promptly identify and address compliance issues.

In some implementations, the integrated CI/CD compliance scanner 300 may include feedback loops and notifications 340 which may notify developers and relevant stakeholders whenever compliance issues are identified. In some examples, the feedback loops and notifications 340 may include actionable insights regarding the compliance issues, including guidance or recommendations for remediation of the compliance issues.

In some implementations, the integrated CI/CD compliance scanner 300 may include automated audit and reporting mechanisms 345, including tools that automatically generate documentation, including compliance-related information, within the CI/CD pipeline. In some examples, the automated audit and reporting mechanisms 345 may ensure that documentation is up-to-date and readily available for reference by developers and stakeholders.

By incorporating the integrated CI/CD compliance scanner 300 into CI/CD automation pipelines, an organization may be able to proactively enforce standards, identify and remediate issues early in the development process, and deliver software that aligns with established compliance and security requirements. For example, the integrated CI/CD compliance scanner 300 may support alignment with industry-leading standards during each stage of application development, including NIST standards (e.g., cybersecurity standards and best practices and risk management frameworks), FFIEC guidelines (e.g., ensuring compliance with specific requirements for financial institutions), and FRB oversight requirements to enhance regulatory compliance for financial institutions. The integrated CI/CD compliance scanner 300 may also support holistic security measures including enforcement of automated checks such as static code scans, secret detection, and container security scanning in accordance with NIST, FFIEC, FRB and any custom organizational standards. Such holistic security measures may provide a comprehensive solution which encompasses coding standards, security best practices, and compliance policies.

In some aspects, the PaC integration within the CI/CD pipeline may also promote consistent adherence to predefined standards, including enforcement of compliance policies in machine-readable format. In addition, the integrated CI/CD compliance scanner 300 may also enforce automated dependency scanning tools to detect vulnerabilities and enhance security by proactively identifying and addressing potential security risks prior to application deployment.

The integrated CI/CD compliance scanner 300 may also support compliance dashboards and reporting, which allows users to monitor compliance status of applications and code at each stage of development within the CI/CD pipeline. The compliance dashboards and reporting may provide stakeholders and developers to visually track, address, and ensure compliance of code during each stage of development, which may enhance the transparency of development and accountability of developers at each stage of the CI/CD pipeline.

The automated and continuous monitoring implemented by the integrated CI/CD compliance scanner 300 may also allow for immediate detection of bugs and standards deviations as they occur, which may allow developers to respond to deviations promptly to minimize security risks, and allows for real-time insights into application security and adherence to compliance policies. In some aspects, the integrated CI/CD compliance scanner 300 may also allow for streamlined auditing processing and regulatory assessments based on improved documentation and frequent scanning to ensure compliance.

The integrated CI/CD compliance scanner 300 may also help notify developers with possible issues identified in the code, which may support improved issue resolution and improved software quality. The integrated CI/CD compliance scanner 300 may also integrate NIST, FFIEC, and FRB standards as PaC frameworks to demonstrate a commitment to meeting and exceeding regulatory expectations, which may builds regulatory confidence and trust with regulatory entities while supporting a proactive approach to compliance with established standards and risk mitigation. The integrated CI/CD compliance scanner 300 may also enhance overall security and reduce the likelihood of security breaches and compliance gaps based on continuous integration within the CI/CD pipeline.

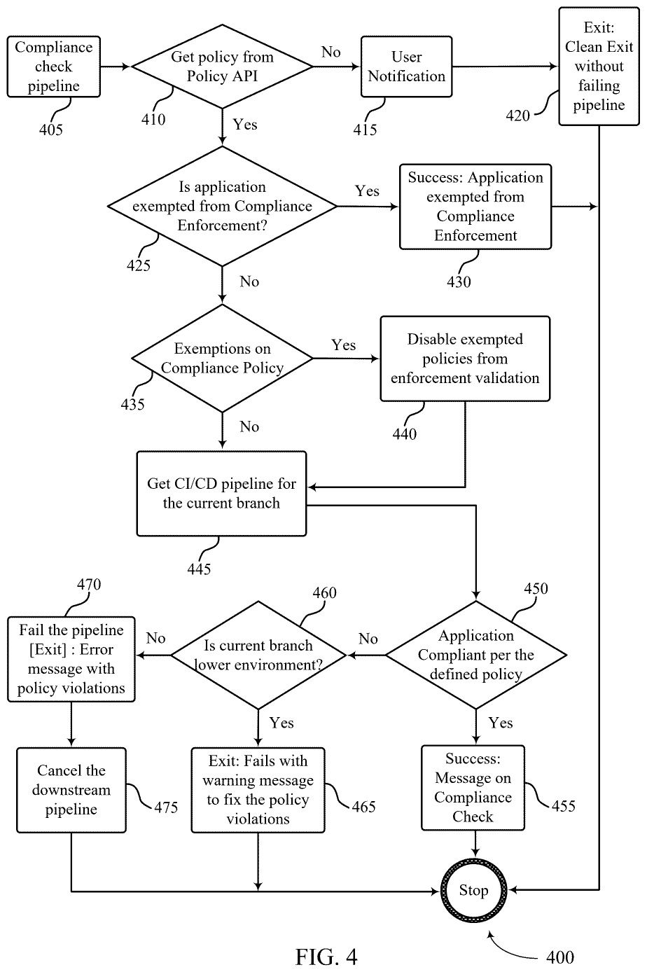

FIG. 4 shows an example of a process flow 400 that supports techniques to enforce standards compliance for CI/CD pipelines in accordance with aspects of the present disclosure. For example, the process flow 400 may support integration of compliance scanning and compliance checks within various portions of a CI/CD pipeline.

In the following description of process flow 400, the operations may be performed in a different order than the order shown, or other operations may be added or removed from the process flow 400. For example, some operations may also be left out of process flow 400, may be performed in different orders or at different times, or other operations may be added to process flow 400. Actions of the process flow 400 may be performed at or by one or more devices or operators.

At 405, the compliance check pipeline is implemented for a CI/CD pipeline. At 410, the compliance check pipeline may attempt to obtain a policy from a policy application programming interface (API). If no relevant policy is available, the compliance check pipeline provides a user notification at 415 (e.g., a Slack or Teams notification, an email notification, or any other notification via a user platform) and then exits the compliance check pipeline at 420 without failing the pipeline (e.g., a clean exit). If the compliance check pipeline is able to obtain a policy from the policy API at 410, at 425 the compliance check pipeline determines whether the application is exempt from compliance enforcement for one or more reasons. If the application is exempt from the compliance enforcement, at 430 the compliance check pipeline indicates a successful exemption for the application and exits the compliance check pipeline at 420 without failing the pipeline. If the application is not exempt from the compliance enforcement, at 435 the compliance check pipeline may identify one or more exemptions to the compliance policy, and may disable any exempted policies from enforcement validation at 440. At 445, the compliance check pipeline may obtain the CI/CD pipeline for the current branch, and may determine whether the application is compliant per the defined compliance policy

If, at 450, the compliance check pipeline determines that the application is compliant per the defined compliance policy, the compliance check pipeline indicates a successful compliance check at 455, delivers a success message, and stops the compliance check pipeline. If, at 450, the compliance check pipeline determines that the application is not in compliance with the defined compliance policy, the compliance check pipeline determines whether the branch is part of a lower environment at 460. If the current branch is part of a lower environment, the compliance check pipeline exits and fails the compliance check at 465. In some examples, the compliance check pipeline may provide a warning message that indicates the policy violations and a prompt to fix the policy violations. If at 460 the compliance check pipeline determines that the branch is not part of a lower environment, the compliance check pipeline may fail the pipeline at 470, which may include generating an error message indicating the policy violations. In some examples, at 475, the compliance check pipeline may fail the downstream pipeline based on the identified policy violations in order to reduce the likelihood of additional violations occurring or being propagated to later stages of development.

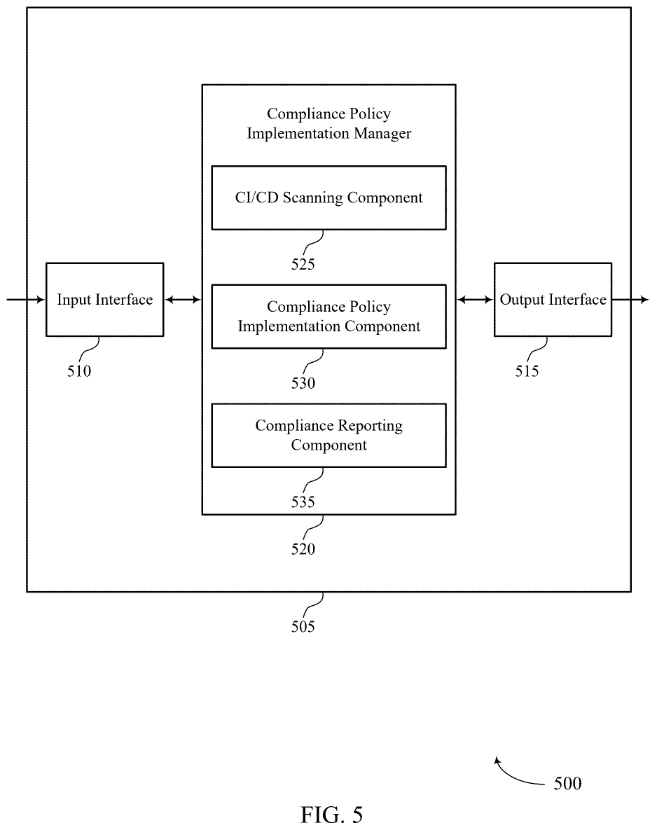

FIG. 5 shows a block diagram 500 of a system 505 that supports techniques to enforce standards compliance for CI/CD pipelines in accordance with aspects of the present disclosure. In some examples, the system 505 may be an example of aspects of one or more components described with reference to FIG. 1, such as a DMS 110. The system 505 may include an input interface 510, an output interface 515, and a compliance policy implementation manager 520. The system 505 may also include one or more processors. Each of these components may be in communication with one another (e.g., via one or more buses, communications links, communications interfaces, or any combination thereof).

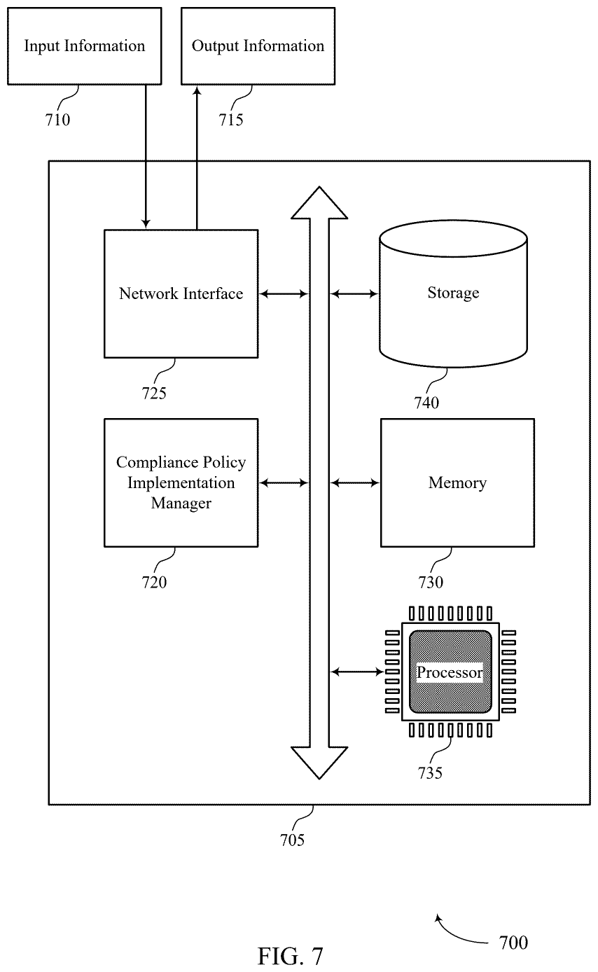

The input interface 510 may manage input signaling for the system 505. For example, the input interface 510 may receive input signaling (e.g., messages, packets, data, instructions, commands, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the compliance policy implementation manager 520 to support techniques to enforce standards compliance for CI/CD pipelines. In some cases, the input interface 510 may be a component of a network interface 725 as described with reference to FIG. 7.

The output interface 515 may manage output signaling for the system 505. For example, the output interface 515 may receive signaling from other components of the system 505, such as the compliance policy implementation manager 520, and may transmit such output signaling corresponding to (e.g., representative of or otherwise based on) such signaling to other systems or devices. In some cases, the output interface 515 may be a component of a network interface 725 as described with reference to FIG. 7.

For example, the compliance policy implementation manager 520 may include a CI/CD scanning component 525, a compliance policy implementation component 530, a compliance reporting component 535, or any combination thereof. In some examples, the compliance policy implementation manager 520, or various components thereof, may be configured to perform various operations (e.g., receiving, monitoring, transmitting) using or otherwise in cooperation with the input interface 510, the output interface 515, or both. For example, the compliance policy implementation manager 520 may receive information from the input interface 510, send information to the output interface 515, or be integrated in combination with the input interface 510, the output interface 515, or both to receive information, transmit information, or perform various other operations as described herein.

The CI/CD scanning component 525 may be configured as or otherwise support a means for implementing, within a CI/CD pipeline for an application, an automatic scanning procedure to enforce compliance of the CI/CD pipeline with one or more standards for computer systems and software. The compliance policy implementation component 530 may be configured as or otherwise support a means for obtaining a compliance policy from an application programming interface associated with the application. The CI/CD scanning component 525 may be configured as or otherwise support a means for performing, in accordance with the compliance policy, one or more static code scans, one or more secret detection scans, one or more container security scans, one or more dependency scans, or any combination thereof, to enforce compliance of the CI/CD pipeline with the one or more standards based on the application being non-exempt from compliance enforcement. The compliance reporting component 535 may be configured as or otherwise support a means for outputting a message indicating results of the one or more static code scans, the one or more secret detection scans, the one or more container security scans, the one or more dependency scans, or any combination thereof.

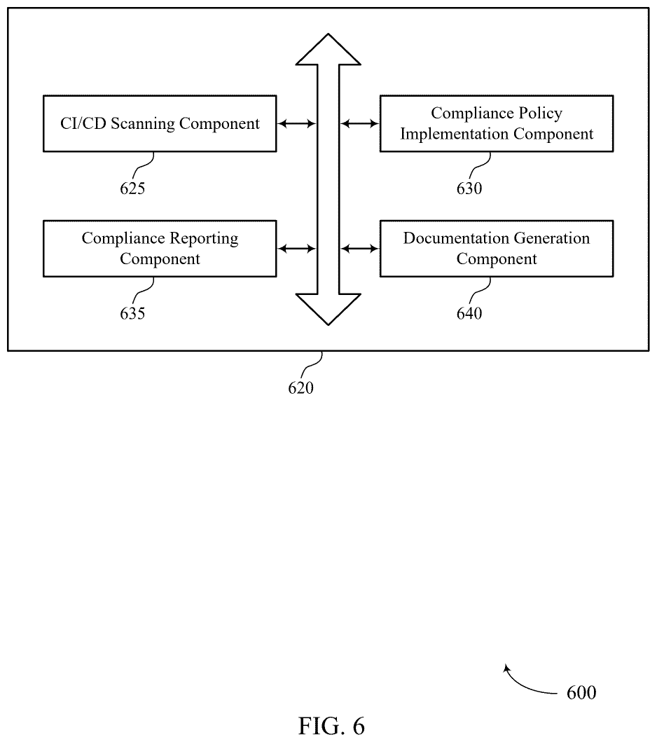

FIG. 6 shows a block diagram 600 of a compliance policy implementation manager 620 that supports techniques to enforce standards compliance for CI/CD pipelines in accordance with aspects of the present disclosure. The compliance policy implementation manager 620 may be an example of aspects of a compliance policy implementation manager or a compliance policy implementation manager 520, or both, as described herein. The compliance policy implementation manager 620, or various components thereof, may be an example of means for performing various aspects of techniques to enforce standards compliance for CI/CD pipelines as described herein. For example, the compliance policy implementation manager 620 may include a CI/CD scanning component 625, a compliance policy implementation component 630, a compliance reporting component 635, a documentation generation component 640, or any combination thereof. Each of these components, or components of subcomponents thereof (e.g., one or more processors, one or more memories), may communicate, directly or indirectly, with one another (e.g., via one or more buses, communications links, communications interfaces, or any combination thereof).

The CI/CD scanning component 625 may be configured as or otherwise support a means for implementing, within a CI/CD pipeline for an application, an automatic scanning procedure to enforce compliance of the CI/CD pipeline with one or more standards for computer systems and software. The compliance policy implementation component 630 may be configured as or otherwise support a means for obtaining a compliance policy from an application programming interface associated with the application. In some examples, the CI/CD scanning component 625 may be configured as or otherwise support a means for performing, in accordance with the compliance policy, one or more static code scans, one or more secret detection scans, one or more container security scans, one or more dependency scans, or any combination thereof, to enforce compliance of the CI/CD pipeline with the one or more standards based on the application being non-exempt from compliance enforcement. The compliance reporting component 635 may be configured as or otherwise support a means for outputting a message indicating results of the one or more static code scans, the one or more secret detection scans, the one or more container security scans, the one or more dependency scans, or any combination thereof.

In some examples, to support performing the one or more static code scans, the CI/CD scanning component 625 may be configured as or otherwise support a means for performing the one or more static code scans prior to deployment of code associated with the application, where the one or more static code scans indicate whether the CI/CD pipeline is in compliance with one or more coding standards, one or more security protocols, one or more compliance guidelines, or any combination thereof. In some examples, the CI/CD scanning component 625 may be configured as or otherwise support a means for performing an automated repository analysis for a code repository associated with the application, where the automated repository analysis enforces compliance of the CI/CD pipeline with the one or more standards.

In some examples, to support performing the one or more secret detection scans, the CI/CD scanning component 625 may be configured as or otherwise support a means for performing the one or more secret detection scans prior to deployment of code associated with the application, where the one or more secret detection scans indicate whether the CI/CD pipeline complies with security protocols for sensitive information included in the code. In some examples, to support obtaining the compliance policy, the compliance policy implementation component 630 may be configured as or otherwise support a means for obtaining the compliance policy as a policy-as-code framework, where the policy-as-code framework defines the compliance policy in a machine-readable format, and where the policy-as-code framework is integrated into the CI/CD pipeline.

In some examples, to support performing the one or more container security scans, the CI/CD scanning component 625 may be configured as or otherwise support a means for performing, at the CI/CD pipeline, the one or more container security scans for the containerized application. In some examples, to support performing the one or more dependency scans, the CI/CD scanning component 625 may be configured as or otherwise support a means for performing, at the CI/CD pipeline, an automated dependency scan associated with one or more dependencies of the application.

In some examples, to support outputting the message indicating the results of the one or more static code scans, the one or more secret detection scans, the one or more container security scans, the one or more dependency scans, or any combination thereof, the compliance reporting component 635 may be configured as or otherwise support a means for outputting the message indicating the results to a user interface after one or more stages of the CI/CD pipeline. In some examples, the documentation generation component 640 may be configured as or otherwise support a means for generating documentation associated with the automatic scanning procedure at the CI/CD pipeline, where the documentation includes compliance related information.

In some examples, the compliance policy implementation component 630 may be configured as or otherwise support a means for determining, based on the one or more static code scans, the one or more secret detection scans, the one or more container security scans, the one or more dependency scans, or any combination thereof, that the application is out of compliance. In some examples, the compliance reporting component 635 may be configured as or otherwise support a means for performing one or more remedial actions at the CI/CD pipeline to restore compliance based on the determination.

In some examples, to support determining that the application is out of compliance, the compliance reporting component 635 may be configured as or otherwise support a means for identifying one or more deviations from the compliance policy or one or more deviations from the one or more standards, or any combination thereof. In some examples, to support performing the one or more remedial actions, the compliance policy implementation component 630 may be configured as or otherwise support a means for canceling the CI/CD pipeline and an associated downstream pipeline.

In some examples, the CI/CD scanning component 625 may be configured as or otherwise support a means for establishing one or more feedback loops at the CI/CD pipeline. In some examples, the CI/CD scanning component 625 may be configured as or otherwise support a means for determining, based on the one or more static code scans, the one or more secret detection scans, the one or more container security scans, the one or more dependency scans, or any combination thereof, that the application is out of compliance. In some examples, the compliance reporting component 635 may be configured as or otherwise support a means for outputting, in accordance with the one or more feedback loops, one or more messages indicating that the application is out of compliance. In some examples, the one or more messages include remediation information to restore compliance.

In some examples, the one or more standards include NIST standards, FFIEC guidelines, FRB oversight requirements, or any combination thereof. In some examples, the one or more standards include standards associated with development of computer systems and software, upkeep of computer systems and software, security protocols of computer systems and software, or any combination thereof.

FIG. 7 shows a block diagram 700 of a system 705 that supports techniques to enforce standards compliance for CI/CD pipelines in accordance with aspects of the present disclosure. The system 705 may be an example of or include components of a system 505 as described herein. The system 705 may include components for data management, including components such as a compliance policy implementation manager 720, an input information 710, an output information 715, a network interface 725, at least one memory 730, at least one processor 735, and a storage 740. These components may be in electronic communication or otherwise coupled with each other (e.g., operatively, communicatively, functionally, electronically, electrically; via one or more buses, communications links, communications interfaces, or any combination thereof). Additionally, the components of the system 705 may include corresponding physical components or may be implemented as corresponding virtual components (e.g., components of one or more virtual machines). In some examples, the system 705 may be an example of aspects of one or more components described with reference to FIG. 1, such as a DMS 110.

The network interface 725 may enable the system 705 to exchange information (e.g., input information 710, output information 715, or both) with other systems or devices (not shown). For example, the network interface 725 may enable the system 705 to connect to a network (e.g., a network 120 as described herein). The network interface 725 may include one or more wireless network interfaces, one or more wired network interfaces, or any combination thereof. In some examples, the network interface 725 may be an example of may be an example of aspects of one or more components described with reference to FIG. 1, such as one or more network interfaces.

Memory 730 may include RAM, ROM, or both. The memory 730 may store computer-readable, computer-executable software including instructions that, when executed, cause the processor 735 to perform various functions described herein. In some cases, the memory 730 may contain, among other things, a basic input/output system (BIOS), which may control basic hardware or software operation such as the interaction with peripheral components or devices. In some cases, the memory 730 may be an example of aspects of one or more components described with reference to FIG. 1, such as one or more memories.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in a memory 730 to perform various functions (e.g., functions or tasks supporting techniques to enforce standards compliance for CI/CD pipelines). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. In some cases, the processor 735 may be an example of aspects of one or more components described with reference to FIG. 1, such as one or more processors.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database. In some examples, the storage 740 may be an example of one or more components described with reference to FIG. 1, such as one or more network disks.

For example, the compliance policy implementation manager 720 may be configured as or otherwise support a means for implementing, within a CI/CD pipeline for an application, an automatic scanning procedure to enforce compliance of the CI/CD pipeline with one or more standards for computer systems and software. The compliance policy implementation manager 720 may be configured as or otherwise support a means for obtaining a compliance policy from an application programming interface associated with the application. The compliance policy implementation manager 720 may be configured as or otherwise support a means for performing, in accordance with the compliance policy, one or more static code scans, one or more secret detection scans, one or more container security scans, one or more dependency scans, or any combination thereof, to enforce compliance of the CI/CD pipeline with the one or more standards based on the application being non-exempt from compliance enforcement. The compliance policy implementation manager 720 may be configured as or otherwise support a means for outputting a message indicating results of the one or more static code scans, the one or more secret detection scans, the one or more container security scans, the one or more dependency scans, or any combination thereof.

By including or configuring the compliance policy implementation manager 720 in accordance with examples as described herein, the system 705 may support techniques for techniques to enforce standards compliance for CI/CD pipelines, which may provide one or more benefits such as, for example, improved reliability, improved user experience, more efficient utilization of computing resources, network resources or both, improved scalability, or improved security, reduced need for manual intervention, higher quality software development, reduced vulnerability due to standards noncompliance, among other possibilities.

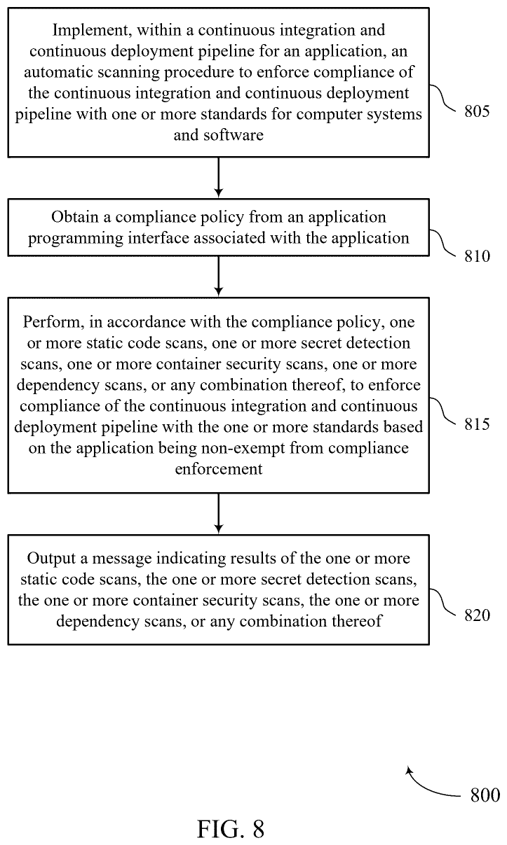

FIG. 8 shows a flowchart illustrating a method 800 that supports techniques to enforce standards compliance for CI/CD pipelines in accordance with aspects of the present disclosure. The operations of the method 800 may be implemented by a DMS or its components as described herein. For example, the operations of the method 800 may be performed by a DMS as described with reference to FIGS. 1 through 7. In some examples, a DMS may execute a set of instructions to control the functional elements of the DMS to perform the described functions. Additionally, or alternatively, the DMS may perform aspects of the described functions using special-purpose hardware.

At 805, the method may include implementing, within a CI/CD pipeline for an application, an automatic scanning procedure to enforce compliance of the CI/CD pipeline with one or more standards for computer systems and software. The operations of 805 may be performed in accordance with examples as disclosed herein. In some examples, aspects of the operations of 805 may be performed by a CI/CD scanning component 625 as described with reference to FIG. 6.

At 810, the method may include obtaining a compliance policy from an application programming interface associated with the application. The operations of 810 may be performed in accordance with examples as disclosed herein. In some examples, aspects of the operations of 810 may be performed by a compliance policy implementation component 630 as described with reference to FIG. 6.

At 815, the method may include performing, in accordance with the compliance policy, one or more static code scans, one or more secret detection scans, one or more container security scans, one or more dependency scans, or any combination thereof, to enforce compliance of the CI/CD pipeline with the one or more standards based on the application being non-exempt from compliance enforcement. The operations of 815 may be performed in accordance with examples as disclosed herein. In some examples, aspects of the operations of 815 may be performed by a CI/CD scanning component 625 as described with reference to FIG. 6.

At 820, the method may include outputting a message indicating results of the one or more static code scans, the one or more secret detection scans, the one or more container security scans, the one or more dependency scans, or any combination thereof. The operations of 820 may be performed in accordance with examples as disclosed herein. In some examples, aspects of the operations of 820 may be performed by a compliance reporting component 635 as described with reference to FIG. 6.

The following provides an overview of aspects of the present disclosure:

Aspect 1: A method, comprising: implementing, within a CI/CD pipeline for an application, an automatic scanning procedure to enforce compliance of the CI/CD pipeline with one or more standards for computer systems and software, wherein the automatic scanning procedure comprises: obtaining a compliance policy from an application programming interface associated with the application; performing, in accordance with the compliance policy, one or more static code scans, one or more secret detection scans, one or more container security scans, one or more dependency scans, or any combination thereof, to enforce compliance of the continuous integration and continuous deployment pipeline with the one or more standards based at least in part on the application being non-exempt from compliance enforcement; and outputting a message indicating results of the one or more static code scans, the one or more secret detection scans, the one or more container security scans, the one or more dependency scans, or any combination thereof.

Aspect 2: The method of aspect 1, wherein performing the one or more static code scans comprises: performing the one or more static code scans prior to deployment of code associated with the application, wherein the one or more static code scans indicate whether the continuous integration and continuous deployment pipeline is in compliance with one or more coding standards, one or more security protocols, one or more compliance guidelines, or any combination thereof.

Aspect 3: The method of any of aspects 1 through 2, further comprising: performing an automated repository analysis for a code repository associated with the application, wherein the automated repository analysis enforces compliance of the continuous integration and continuous deployment pipeline with the one or more standards.

Aspect 4: The method of any of aspects 1 through 3, wherein performing the one or more secret detection scans comprises: performing the one or more secret detection scans prior to deployment of code associated with the application, wherein the one or more secret detection scans indicate whether the continuous integration and continuous deployment pipeline complies with security protocols for sensitive information included in the code.

Aspect 5: The method of any of aspects 1 through 4, wherein obtaining the compliance policy comprises: obtaining the compliance policy as a policy-as-code framework, wherein the policy-as-code framework defines the compliance policy in a machine-readable format, and wherein the policy-as-code framework is integrated into the continuous integration and continuous deployment pipeline.

Aspect 6: The method of any of aspects 1 through 5, wherein the application comprises a containerized application, and wherein performing the one or more container security scans comprises: performing, at the continuous integration and continuous deployment pipeline, the one or more container security scans for the containerized application.

Aspect 7: The method of any of aspects 1 through 6, wherein performing the one or more dependency scans comprises: performing, at the continuous integration and continuous deployment pipeline, an automated dependency scan associated with one or more dependencies of the application.

Aspect 8: The method of any of aspects 1 through 7, wherein outputting the message indicating the results of the one or more static code scans, the one or more secret detection scans, the one or more container security scans, the one or more dependency scans, or any combination thereof, comprises: outputting the message indicating the results to a user interface after one or more stages of the continuous integration and continuous deployment pipeline.

Aspect 9: The method of any of aspects 1 through 8, further comprising: generating documentation associated with the automatic scanning procedure at the continuous integration and continuous deployment pipeline, wherein the documentation comprises compliance related information.

Aspect 10: The method of any of aspects 1 through 9, further comprising: determining, based at least in part on the one or more static code scans, the one or more secret detection scans, the one or more container security scans, the one or more dependency scans, or any combination thereof, that the application is out of compliance; and performing one or more remedial actions at the continuous integration and continuous deployment pipeline to restore compliance based at least in part on the determination.

Aspect 11: The method of aspect 10, wherein determining that the application is out of compliance comprises: identifying one or more deviations from the compliance policy or one or more deviations from the one or more standards, or any combination thereof.

Aspect 12: The method of any of aspects 10 through 11, wherein performing the one or more remedial actions comprises: canceling the continuous integration and continuous deployment pipeline and an associated downstream pipeline.

Aspect 13: The method of any of aspects 1 through 12, further comprising: establishing one or more feedback loops at the continuous integration and continuous deployment pipeline; determining, based at least in part on the one or more static code scans, the one or more secret detection scans, the one or more container security scans, the one or more dependency scans, or any combination thereof, that the application is out of compliance; and outputting, in accordance with the one or more feedback loops, one or more messages indicating that the application is out of compliance.

Aspect 14: The method of aspect 13, wherein the one or more messages include remediation information to restore compliance.

Aspect 15: The method of any of aspects 1 through 14, wherein the one or more standards comprise National Institute of Standards and Technology (NIST) standards, Federal Financial Institutions Examination Council (FFIEC) guidelines, Federal Reserve Board (FRB) oversight requirements, or any combination thereof.

Aspect 16: The method of any of aspects 1 through 15, wherein the one or more standards comprise standards associated with development of computer systems and software, upkeep of computer systems and software, security protocols of computer systems and software, or any combination thereof.

Aspect 17: An apparatus comprising one or more memories storing processor-executable code, and one or more processors coupled with the one or more memories and individually or collectively operable to execute the code to cause the apparatus to perform a method of any of aspects 1 through 16.

Aspect 18: An apparatus comprising at least one means for performing a method of any of aspects 1 through 16.

Aspect 19: A non-transitory computer-readable medium storing code the code comprising instructions executable by one or more processors to perform a method of any of aspects 1 through 16.

It should be noted that the methods described herein describe possible implementations, and that the operations and the steps may be rearranged or otherwise modified and that other implementations are possible. Further, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, “a component” having characteristics or performing functions may refer to “at least one of one or more components” having a particular characteristic or performing a particular function. Subsequent reference to a component introduced with the article “a” using the terms “the” or “said” refers to any or all of the one or more components. For example, a component introduced with the article “a” shall be understood to mean “one or more components,” and referring to “the component” subsequently in the claims shall be understood to be equivalent to referring to “at least one of the one or more components.”

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
implementing, within a continuous integration and continuous deployment pipeline for an application, an automatic scanning procedure to enforce compliance of the continuous integration and continuous deployment pipeline with one or more standards for computer systems and software, wherein the automatic scanning procedure comprises:
obtaining a compliance policy from an application programming interface associated with the application;
performing, in accordance with the compliance policy, one or more static code scans, one or more secret detection scans, one or more container security scans, one or more dependency scans, or any combination thereof, to enforce compliance of the continuous integration and continuous deployment pipeline with the one or more standards based at least in part on the application being non-exempt from compliance enforcement; and
outputting a message indicating results of the one or more static code scans, the one or more secret detection scans, the one or more container security scans, the one or more dependency scans, or any combination thereof.

2. The method of claim 1, wherein performing the one or more static code scans comprises:
performing the one or more static code scans prior to deployment of code associated with the application, wherein the one or more static code scans indicate whether the continuous integration and continuous deployment pipeline is in compliance with one or more coding standards, one or more security protocols, one or more compliance guidelines, or any combination thereof.

3. The method of claim 1, further comprising:
performing an automated repository analysis for a code repository associated with the application, wherein the automated repository analysis enforces compliance of the continuous integration and continuous deployment pipeline with the one or more standards.

4. The method of claim 1, wherein performing the one or more secret detection scans comprises:
performing the one or more secret detection scans prior to deployment of code associated with the application, wherein the one or more secret detection scans indicate whether the continuous integration and continuous deployment pipeline complies with security protocols for sensitive information included in the code.

5. The method of claim 1, wherein obtaining the compliance policy comprises:
obtaining the compliance policy as a policy-as-code framework, wherein the policy-as-code framework defines the compliance policy in a machine-readable format, and wherein the policy-as-code framework is integrated into the continuous integration and continuous deployment pipeline.

6. The method of claim 1, wherein the application comprises a containerized application, and wherein performing the one or more container security scans comprises:
performing, at the continuous integration and continuous deployment pipeline, the one or more container security scans for the containerized application.

7. The method of claim 1, wherein performing the one or more dependency scans comprises:
performing, at the continuous integration and continuous deployment pipeline, an automated dependency scan associated with one or more dependencies of the application.

8. The method of claim 1, wherein outputting the message indicating the results of the one or more static code scans, the one or more secret detection scans, the one or more container security scans, the one or more dependency scans, or any combination thereof, comprises:
outputting the message indicating the results to a user interface after one or more stages of the continuous integration and continuous deployment pipeline.

9. The method of claim 1, further comprising:
generating documentation associated with the automatic scanning procedure at the continuous integration and continuous deployment pipeline, wherein the documentation comprises compliance related information.

10. The method of claim 1, further comprising:
determining, based at least in part on the one or more static code scans, the one or more secret detection scans, the one or more container security scans, the one or more dependency scans, or any combination thereof, that the application is out of compliance; and
performing one or more remedial actions at the continuous integration and continuous deployment pipeline to restore compliance based at least in part on the determination.

11. The method of claim 10, wherein determining that the application is out of compliance comprises:
identifying one or more deviations from the compliance policy or one or more deviations from the one or more standards, or any combination thereof.

12. The method of claim 10, wherein performing the one or more remedial actions comprises:
canceling the continuous integration and continuous deployment pipeline and an associated downstream pipeline.

13. The method of claim 1, further comprising:
establishing one or more feedback loops at the continuous integration and continuous deployment pipeline;
determining, based at least in part on the one or more static code scans, the one or more secret detection scans, the one or more container security scans, the one or more dependency scans, or any combination thereof, that the application is out of compliance; and
outputting, in accordance with the one or more feedback loops, one or more messages indicating that the application is out of compliance.

14. The method of claim 13, wherein the one or more messages include remediation information to restore compliance.

15. The method of claim 1, wherein the one or more standards comprise National Institute of Standards and Technology (NIST) standards, Federal Financial Institutions Examination Council (FFIEC) guidelines, Federal Reserve Board (FRB) oversight requirements, or any combination thereof.

16. The method of claim 1, wherein the one or more standards comprise standards associated with development of computer systems and software, upkeep of computer systems and software, security protocols of computer systems and software, or any combination thereof.

17. A non-transitory computer-readable medium storing code, the code comprising instructions executable by one or more processors to:
implement, within a continuous integration and continuous deployment pipeline for an application, an automatic scanning procedure to enforce compliance of the continuous integration and continuous deployment pipeline with one or more standards for computer systems and software, wherein the automatic scanning procedure comprises:
obtain a compliance policy from an application programming interface associated with the application;
perform, in accordance with the compliance policy, one or more static code scans, one or more secret detection scans, one or more container security scans, one or more dependency scans, or any combination thereof, to enforce compliance of the continuous integration and continuous deployment pipeline with the one or more standards based at least in part on the application being non-exempt from compliance enforcement; and
output a message indicating results of the one or more static code scans, the one or more secret detection scans, the one or more container security scans, the one or more dependency scans, or any combination thereof.

18. The non-transitory computer-readable medium of claim 17, wherein the instructions to perform the one or more static code scans are executable by the one or more processors to:
perform the one or more static code scans prior to deployment of code associated with the application, wherein the one or more static code scans indicate whether the continuous integration and continuous deployment pipeline is in compliance with one or more coding standards, one or more security protocols, one or more compliance guidelines, or any combination thereof.

19. The non-transitory computer-readable medium of claim 17, wherein the instructions are further executable by the one or more processors to:
perform an automated repository analysis for a code repository associated with the application, wherein the automated repository analysis enforces compliance of the continuous integration and continuous deployment pipeline with the one or more standards.

20. An apparatus, comprising:
one or more memories storing processor-executable code; and
one or more processors coupled with the one or more memories and individually or collectively operable to execute the code to cause the apparatus to:
implement, within a continuous integration and continuous deployment pipeline for an application, an automatic scanning procedure to enforce compliance of the continuous integration and continuous deployment pipeline with one or more standards for computer systems and software, wherein the automatic scanning procedure comprises:
obtain a compliance policy from an application programming interface associated with the application;
perform, in accordance with the compliance policy, one or more static code scans, one or more secret detection scans, one or more container security scans, one or more dependency scans, or any combination thereof, to enforce compliance of the continuous integration and continuous deployment pipeline with the one or more standards based at least in part on the application being non-exempt from compliance enforcement; and
output a message indicating results of the one or more static code scans, the one or more secret detection scans, the one or more container security scans, the one or more dependency scans, or any combination thereof.
